(19) United States
(12) Patent Application Publication
(10) Pub. No.: US 2004/0247267 A1
(43) Pub. Date: Dec. 9, 2004

(54) Light guide sheet material and method of manufacturing the sheet material

(76) Inventor: Genji Imai, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/491,541

(22) PCT Filed: Oct. 3, 2002
(86) PCT No.: PCT/JP02/10325

(30) Foreign Application Priority Data
Oct. 4, 2001 (JP) 2001-309115

(51) Int. Cl. G02B 6/44

(52) U.S. Cl. 385/114

(57) ABSTRACT

The present invention relates to fabricating an optimal sheet material for optical waveguide use. In this optical waveguide sheet material, optical waveguide fibers that are constituted by cores and cladding in a plastic sheet base material pass through the sheet material in the direction of thickness of the sheet material, and moreover, a plurality of optical waveguide fibers are arranged parallel to each other. The method of fabricating this sheet material includes steps of forming a plurality of optical waveguide fibers as a bundle by fusion-bonding or pressure-bonding using a plastic base material, and then forming a sheet by cutting this bundle of optical waveguide fibers such that the surface of the sheet is orthogonal to the fiber direction of the optical waveguide fibers.

### BACKGROUND OF THE INVENTION

1. Field of the Invention

The present invention relates to optical waveguide sheet material in which optical waveguide fibers that are made up of cores and cladding pass through a plastic sheet material in the direction of thickness of the sheet material, and moreover, in which a plurality of the optical waveguide fibers are arranged parallel to each other, and to a method of fabricating this optical waveguide sheet material.

2. Description of the Related Art

The development of increasingly multifunctional, compact, and light electronic equipment in recent years has brought with it new techniques for producing integrated optical circuits on chips in the semiconductor field. As an example, integrated optical circuits are being developed in which super-micro-fabrication techniques are used to incorporate extremely small light paths (for optical waveguides) inside silicon, whereby light is orthogonally bent and subjected to signal processing without being converted to electrical signals. Nevertheless, this field has yet to overcome problems such as the leakage of light, the linear nature of light, and various difficulties encountered in fabrication.

### SUMMARY OF THE INVENTION

The present invention was developed with the object of solving the above-described problems of the prior art.

The inventors of the present invention, as a result of determined research to solve the above-described problems, have succeeded in discovering that an optical waveguide sheet material, in which optical waveguide fibers that are each constituted by a core and cladding pass through a plastic sheet material in the direction of thickness of the sheet material, and moreover, in which a plurality of these optical waveguide fibers are arranged parallel to each other, is capable of providing a solution to the above-described problems, and have thus realized the present invention.

More specifically, the present invention relates to: optical waveguide sheet material in which optical waveguide fibers that are each made up of a core and cladding pass through a plastic sheet base material in the direction of thickness of the sheet base material, and moreover, in which a plurality of optical waveguide fibers are arranged parallel to each other; a method of fabricating this optical waveguide sheet material; and, in an optical waveguide-type optical circuit in which an optical waveguide that is made up of cores and cladding is formed on a substrate, an optical circuit in which the above-described optical waveguide sheet material is used in a portion or the entirety of the optical waveguides.

### BRIEF DESCRIPTION OF THE DRAWINGS

FIG. 1 shows sectional views of the optical waveguide sheet material that relates to the present invention as seen from the side surface (thickness) as well as plan views as seen from above.

FIG. 2 shows the fabrication method of the optical waveguide sheet material that relates to the present invention.

FIG. 3 shows the fabrication method of the optical waveguide sheet material by means of a positive type according to the present invention.

FIG. 4 shows the fabrication method of the optical waveguide sheet material by means of a negative type according to the present invention.

FIG. 5 shows an example of the use of the optical waveguide sheet material that relates to the present invention.

FIG. 6 shows an example of the use of the optical waveguide sheet material that relates to the present invention.

### DETAILED DESCRIPTION OF THE PREFERRED EMBODIMENTS

Embodiments of the present invention are next described.

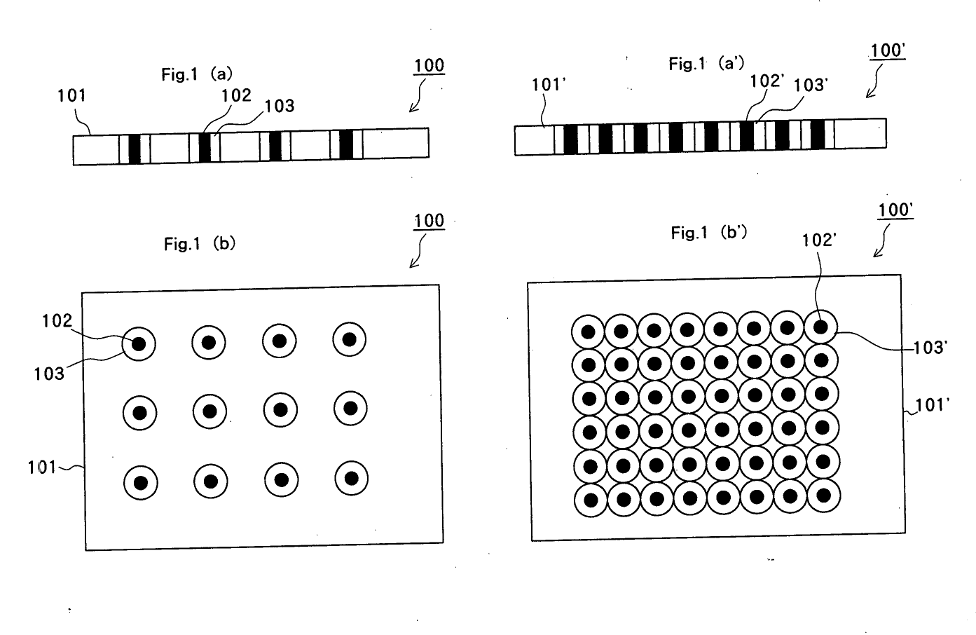

FIG. 1(a) and FIG. 1(a′) are sectional views of optical waveguide sheet material 100 and 100i relating to the present invention as seen from the side (thickness). FIG. 1(b) and FIG. 1(b′) are plan views of optical waveguide sheet material 100 and 100′ as seen from above. Of these views, FIG. 1(a) and FIG. 1(b) show optical waveguide sheet material 100 having few optical waveguide fibers, and FIG. 1(b) and FIG. 1(b′) show optical waveguide sheet material 100′ that has a large number of optical waveguide fibers.

As shown in FIG. 1, optical waveguide sheet materials 100 and 100′ are constructions in which optical waveguide fibers that are made up of cores 102 and 102′ and cladding 103 and 103′ are arranged in plastic sheets 101 and 101′. The optical waveguide fibers pass through plastic sheets 101 and 101′ in the direction of thickness of the sheets, and moreover, are arranged with the plurality of fibers parallel to each other.

Materials that are well known in the prior art may be used as the cores 102 and 102′ and cladding 103 and 103′ that make up the optical waveguide fibers. Materials are used such that the index of refraction of cores 102 and 102′ is greater than the index of refraction of cladding 103 and 103′. In addition, in the case of a construction in which the plastic sheets 101 and 101′ themselves function as cladding 103 and 103′, energy-ray sensitive plastic sheets 101 and 101′ can be used that have a lower index of refraction than the index of refraction of cores 102 and 102′.

The cladding that constitutes the optical waveguide fibers is preferably a substance that absorbs incident light, both to prevent signal interference from adjacent optical waveguide fibers as well as to prevent signal interference in cases in which the size of incident light rays is greater than cores or in which the optical axes diverge. Specifically, the absorbance ε(λ) for light of wavelength (that passes through the core is preferably 0.01 to 4, and more preferably 0.1 to 2.

The optical waveguide fibers may be covered optical waveguide fibers in which the outer peripheries of the optical waveguide fibers are covered by one or more types of optical fiber resin.

The optical waveguide fibers preferably have a diameter of 0.001 mm to 2 mm, and more preferably have a diameter of 0.003 mm to 1.5 mm.

In the optical waveguide fibers, the minimum separation between adjacent waveguide fibers that are arranged parallel to each other is preferably 0.01 μm or greater, and more preferably 0.1 μm to 100 μm.

In optical waveguide sheets 100 and 100′, the number of optical waveguide fibers that are arranged in the plastic sheet base material is preferably 500 to 40,000 per 100 cm² of the surface area of the plastic, and more preferably 1,000 to 20,000 per 100 cm².

No particular restrictions are placed on plastic sheets 101 and 101′, but examples of resins that can be used include vinyl ether resin, acrylic resin, urethane resin, polyester resin, silicone resin, fluorocarbon resin, epoxy resin, polyimide resin, polybenzoxazole resin, polycarbonate resin, phenolic resin, cyanate resin, bisumaleimide resin, a composite resin composed of two or more of these resins, or a modified resin that has been chemically bonded. These resins may also be fluorinated or deuterated.

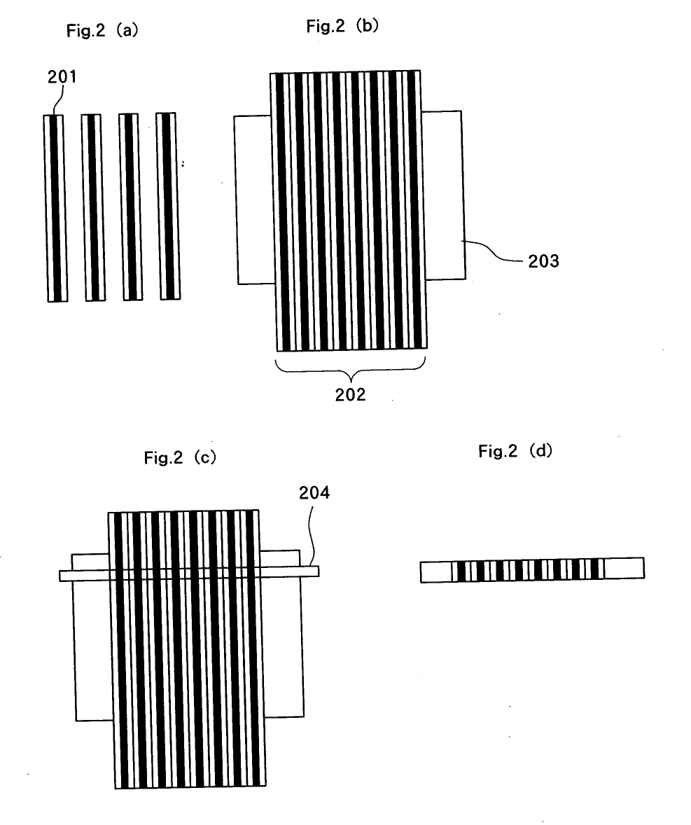

FIG. 2 shows the fabrication method of the optical waveguide sheet material according to the present invention.

The present fabrication method includes steps of:

forming a plurality of optical waveguide fibers in a bundle that is bonded together by pressure-bonding or fusion-bonding by means of a plastic base material; and

forming a sheet by slicing the bundle of optical waveguide fibers such that the surface plane of the sheet is orthogonal to the direction of the fibers of the optical waveguide fibers.

FIG. 2(a) is a sectional view of the side surface of a plurality of the optical waveguide fibers; and FIG. 2(b) is a sectional view of the side surface of the optical waveguide fiber bundle that has been fixed by a securing material (for example, a thermoplastic resin). FIG. 2(c) is a sectional view of the side surface of the fixed optical waveguide fiber bundle that is converted to sheets by dicing (cutting); and FIG. 2(d) is a sectional view of the side surface of a completed optical waveguide sheet.

Optical waveguide fiber 201 that is composed of cores 102 and cladding 103 shown in FIG. 2(a) (refer to FIG. 1) is made into optical waveguide fiber bundle 202 in which a plurality of fibers is bundled by means of securing material 203, as shown in FIG. 2(b). This bundle is subsequently converted to optical waveguide sheet 203 by dicing (cutting) as shown in FIG. 2(c) and thus converted to optical waveguide sheet that is shown in FIG. 2(d).

In the above-described fabrication method, the fabrication steps may be continuous or non-continuous (batch process). In addition, the end surface may be subjected to a polishing process after cutting.

In addition, as a method of securing optical waveguide fibers 201 by means of securing material (for example, thermoplastic resin) 203, the outer peripheries of optical waveguide fibers 201 can be coated in advance with a fusing resin (thermoforming resin), the bundled optical waveguide fibers 201 then heated and subjected to heat and pressure to produce a plastic composition of optical waveguide fibers 201, or alternatively, optical waveguide fibers 201 and resin for thermoforming processing can be subjected to molded plastic processing to produce a plastic formed article.

Still further, a resin that is cured by activation energy rays (such as light, ultraviolet rays, or radiated rays) or heat rays (such as infrared rays) can be used as securing material 203 on a bundle of the above-described optical waveguide fibers 201, following which this curing resin is cured.

Explanation next regards another fabrication method of the optical waveguide sheet material of the present invention. This fabrication method includes steps of

(1) forming a resin layer that is sensitive to activation energy rays;

(2) irradiating activation energy rays either directly or by way of a mask from the surface of the resin layer that is sensitive to activation energy rays that has been formed such that optical waveguide fibers that are each constituted by a core and cladding pass through the resin sheet in the direction of thickness of the sheet material, and moreover, such that a plurality of optical waveguide fibers are arranged parallel to each other.

The above-described method of fabricating an optical waveguide sheet material can be realized by means of a positive type and a negative type.

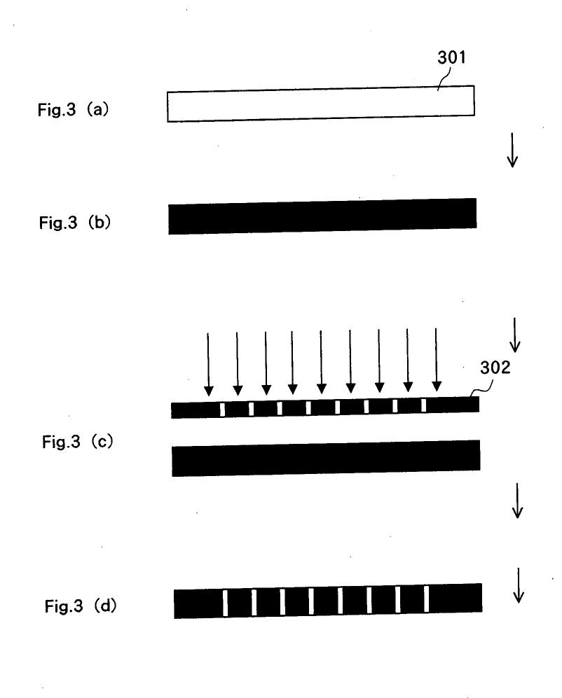

Explanation is first presented regarding the fabrication method that uses the positive type with reference to FIG. 3, which shows the fabrication steps in stages.

First, as shown in FIG. 3(a), sheet material 301 is first prepared in which a positive-type (such as a photo-sensitive or heat-sensitive) plastic composition has been applied as necessary to the surface of a base material such as a releasable film.

Next, as shown in FIG. 3(b), sheet material 301 is heated to crosslink the positive-type resin composition.

Activation energy rays are next irradiated by way of mask 302 (or directly) from the surface of the crosslinked positive-type resin film, as shown in FIG. 3(c). Heat is next applied to produce the state shown in FIG. 3(d).

In the above-described method that employs a positive type, the applied film, which is a positive-type photo-sensitive applied film that has been heat-cured, is exposed to the irradiation of ultraviolet rays or visible light rays, whereby the irradiated crosslinked portions are cut. The cured portions and partially cured portions that are created by these irradiated portions and unexposed portions produce differences in the density of the crosslinking of the applied film, and these differences in density in turn give rise to differences in the index of refraction, and these differences in the index of refraction have the same effect as core and cladding. The present method therefore produces a construction that has an effect that is equivalent to optical waveguide fibers. As the positive-type resin composition, a construction that is well known in the prior art can be employed without any particular restrictions.

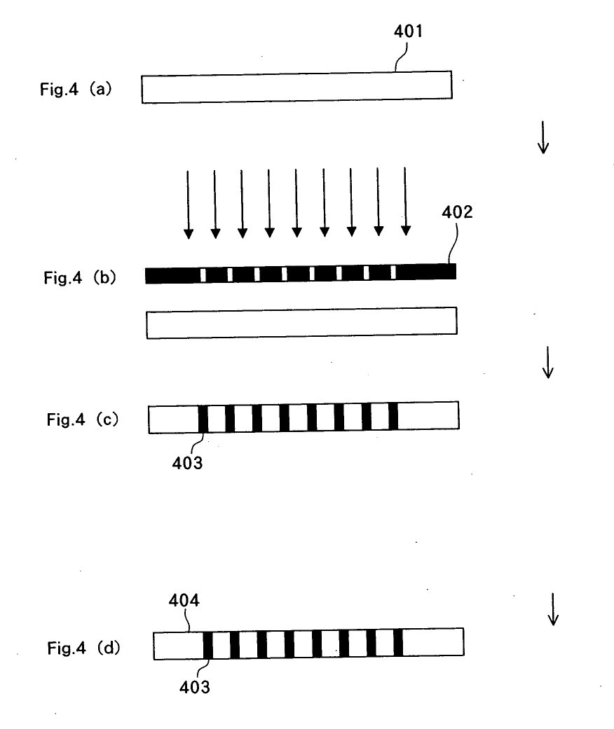

Explanation next regards the fabrication method of the negative type with reference to FIG. 4, which shows the fabrication steps in stages.

Uncured negative-type resin film 401 is first prepared as shown in FIG. 4(a). Next, as shown in FIG. 4(b), activation energy rays are irradiated by way of mask 402 (or directly) from the surface of the negative-type resin film to produce a state in which crosslinked portions 403 are formed in the irradiated portions, as shown in FIG. 4(c).

Heat is next applied, whereby, as shown in FIG. 4(d), non-crosslinked portions 404 are cured, and by mixing foam (foaming agent mixture) or polymer particles, the index of refraction of non-crosslinked portions 404 is adjusted to a level lower than that of crosslinked portions 403.

The negative-type fabrication method is a method of irradiating a negative-type film, then carrying out a process of curing different portions to reduce the index of refraction. The present method creates differences in the index of refraction for light in these film portions and thus produces the effect of cores and cladding, thereby forming a construction that is equivalent in effect to optical waveguide fibers.

Further, in addition to the above-described method, a method may be employed in which a first-stage exposure of the negative-type film is carried out, followed by a second-stage exposure in different portions. Varying the intensities of the first-stage and second-stage exposures produces differences in the density of crosslinking of the applied film, thereby giving rise to differences in the index of refraction of light to produce the effect of cores and cladding. In this way, a construction can be formed that is equivalent in effect to optical waveguide fibers.

Techniques for adjusting the index of refraction in portions by irradiating light and thereby confining and transmitting light is disclosed in Japanese Patent Laid-Open Publication No. 1999-44827 and in Japanese Patent Laid-Open Publication No. 2000-281421.

These techniques can be applied to the fabrication method that was shown in FIG. 3 and FIG. 4 to create differences in the index of refraction of light and thus to produce the effect of cores and cladding. In this way, a construction can be formed that is equivalent in effect to optical fibers.

The optical waveguide sheet of the present invention can be used as a light-emitting sheet material and light-receiving sheet material in a device for coupling light; or alternatively, the optical waveguide sheet of the present invention can be used in a portion or the entirety of an optical waveguide in an optical waveguide-type optical circuit in which an optical waveguide is constituted by cores and cladding on a substrate.

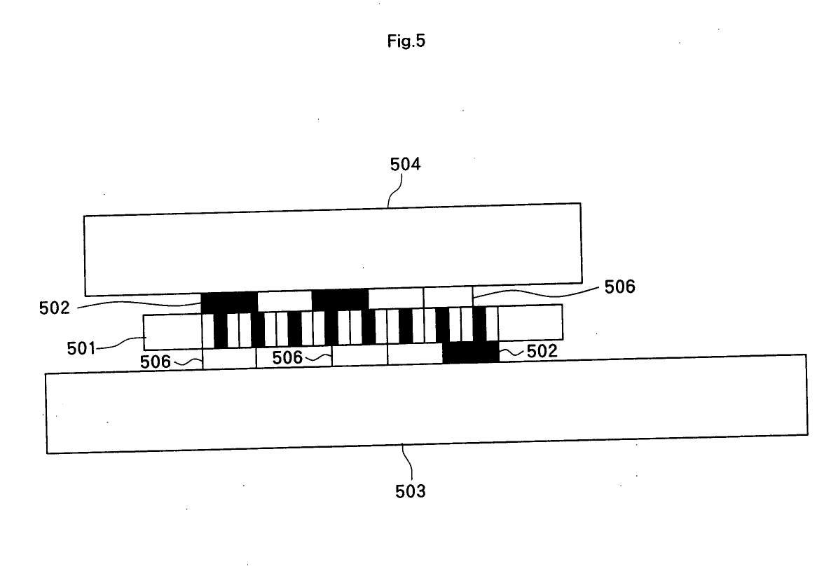

FIG. 5 shows a device in which an optical waveguide sheet according to the present invention is installed between a light-emitting element that is provided In an electronic photonics device and a light-receiving element that is provided on a package substrate.

Optical waveguide sheet 501 according to the present invention is mounted on package substrate 503, and connected to package substrate 503 and electronic-photonics device 504 that is capable of ultra-fast computation by way of light-emitting elements 502 such as surface-emitting lasers and light-receiving elements 506. An optical circuit is formed by supplying the output light from light-emitting elements 502, which is controlled to the amount of light that is required in package substrate 503, to the light-receiving elements.

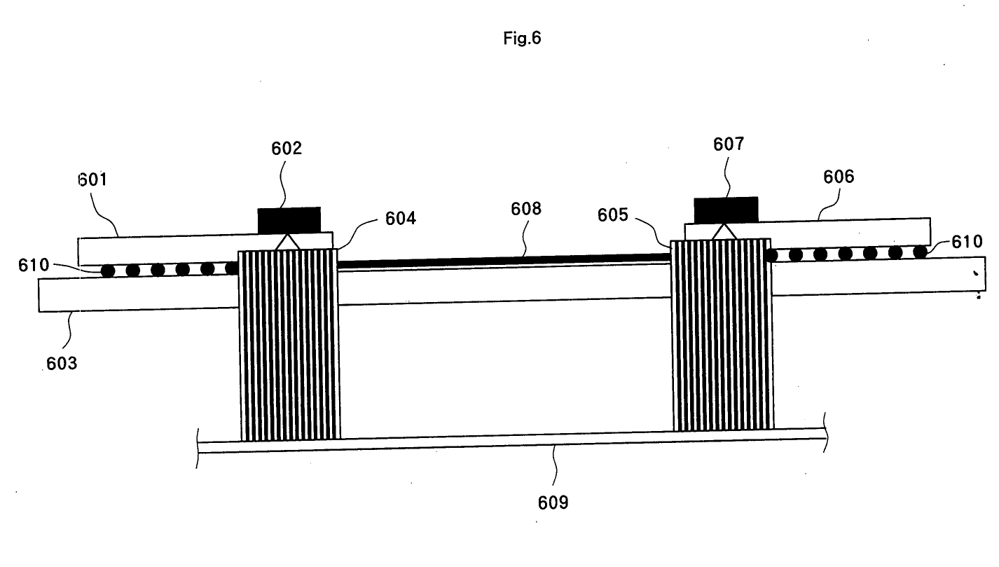

FIG. 6 shows an example of an application in which the optical waveguide sheet of the present invention is used to form an optical wired circuit. LSI chips 601 and 606 are mounted on printed substrate 601 via solder bumps 610. Optical element units 602 and 607 that are made up from light-emitting elements and light-receiving elements are formed on a portion of each of LSI chips 601 and 606, and these optical element units 602 and 607 chiefly implement signal transfer and are connected to high-speed optical bus line 609 that is provided outside printed substrate 601 by way of optical waveguide sheets 604 and 605 according to the present invention. In addition, LSI chips 601 and 606 are also connected on printed substrate 601 by way of low-speed metal lines 608 for transmitting high-current signals that are principally electrical power.

1. An optical waveguide sheet in which optical waveguide fibers that are constituted from cores and cladding are provided in a plastic sheet; wherein:
said optical waveguide fibers pass through said plastic sheet in the direction of thickness of said plastic sheet, and moreover,
a plurality of said optical waveguide fibers are arranged parallel to each other.

2. An optical waveguide sheet according to claim 1, wherein:
the outer peripheries of said optical waveguide fibers are covered by one or more heat-fusing resins.

3. An optical waveguide sheet according to either one of claim 1 and claim 2, wherein:
the absorbance ε(λ) of said cladding that constitutes said optical waveguide fibers with respect to light of wavelength λ that is transmitted by said cores is within the range from 0.01 to 4.

4. An optical waveguide sheet according to claim 3, wherein:
the absorbance ε(λ) of said cladding that constitutes said optical waveguide fibers with respect to light of wavelength λ that is transmitted by said cores is within the range from 0.1 to 2.

5. An optical waveguide sheet according to any one of claims 1 and 2, wherein:
the diameter of said optical waveguide fibers is within the range from 0.001 mm to 2 mm.

6. An optical waveguide sheet according to any one of claims 1 and 2, wherein:
said optical waveguide fibers are arranged such that the minimum distance between adjacent said optical waveguide fibers is at least 0.01 μm.

7. An optical waveguide sheet according to any one of claims 1 and 2, wherein:
the number of optical waveguide fibers that are arranged in a plastic sheet is within the range from 2,500 to 40,000 per 100 cm2 of the surface area of the plastic sheet.

8. An optical waveguide sheet according to any one of claims 1 and 2, wherein:
the index of refraction of said plastic sheet is less than the index of refraction of said cladding of said optical waveguide fibers.

9. An optical waveguide sheet according to any one of claims 1 and 2, wherein:
said plastic sheet is a urethane resin.

10. A method of fabricating an optical waveguide sheet, comprising steps of:
forming a plurality of optical waveguide fibers in a bundle that is bonded together by pressure-bonding or fusion-bonding by means of a plastic base material; and
forming a sheet by slicing said bundle of optical waveguide fibers such that the surface plane of said sheet is orthogonal to the direction of fibers of said optical waveguide fibers.

11. A method of fabricating an optical waveguide sheet, comprising steps of:
forming, on a sheet material, a resin layer that is sensitive to activation energy rays; and
irradiating activation energy rays either directly or by way of a mask from the surface of said resin layer that is sensitive to activation energy rays that has been formed such that optical waveguide fibers pass through said sheet material in the direction of thickness of said sheet material, and moreover, such that a plurality of said optical waveguide fibers are arranged parallel to each other.

12. A method of fabricating an optical waveguide sheet, comprising steps of:
heating a sheet to which a positive-type resin composition has been applied to crosslink a positive-type resin composition;
irradiating activation energy rays from the surface of said crosslinked positive-type resin film, either directly or by way of a mask, to cut the crosslinking of irradiated portions;
heating the entire sheet including portions in which crosslinking has been cut.

13. A method of fabricating an optical waveguide sheet, comprising steps of:
to a sheet to which a negative-type resin composition has been applied, irradiating activation energy rays either directly or by way of a mask to cause crosslinking in irradiated portions;
heating to both cure non-crosslinked portions and mixing foam or polymer particles to adjust such that the index of refraction of non-crosslinked portions is lower than crosslinked portions.

14. A method of fabricating an optical waveguide sheet, wherein:
irradiating activation energy rays either directly or by way of a mask is performed two times while changing the intensity of irradiation to thereby create differences in the index of refraction of light that result from differences in the density of crosslinking and thus produce the effect of cores and cladding such that optical waveguide fibers are formed that pass through said sheet material in the direction of thickness of said sheet material, and moreover, such that a plurality of said optical waveguide fibers are arranged parallel to each other.

15. A method of fabricating an optical waveguide sheet, comprising a step of:
with respect to sheet material in which the index of refraction is adjusted by the irradiation of light, irradiating activation energy rays from the surface either directly or by way of a mask.

16. A method of fabricating an optical waveguide sheet, wherein:
with respect to sheet material in which the index of refraction is adjusted by the irradiation of light, irradiating activation energy rays either directly by way of a mask is performed two times while changing the intensity of irradiation to thereby create differences in the index of refraction of light and thus produce the effect of cores and cladding such that optical waveguide fibers are formed that pass through said sheet material in the direction of thickness of said sheet material, and moreover, such that a plurality of said optical waveguide fibers are arranged parallel to each other.

17. An optical waveguide sheet according to claim 4, wherein:
the diameter of said optical waveguide fibers is within the range from 0.001 mm to 2 mm.

18. An optical waveguide sheet according to claim 5, wherein:
said optical waveguide fibers are arranged such that the minimum distance between adjacent said optical waveguide fibers is at least 0.01 μm.

19. An optical waveguide sheet according to claim 6, wherein:
the number of optical waveguide fibers that are arranged in a plastic sheet is within the range from 2,500 to 40,000 per 100 cm2 of the surface area of the plastic sheet.

20. An optical waveguide sheet according to claim 7, wherein:
the index of refraction of said plastic sheet is less than the index of refraction of said cladding of said optical waveguide fibers.

21. An optical waveguide sheet according to claim 8, wherein:
said plastic sheet is a urethane resin.
